(19) United States
(12) Patent Application Publication
(10) Pub. No.: US 2022/0009018 A1
(43) Pub. Date: Jan. 13, 2022

(54) SYSTEM AND METHOD FOR CONTROLLING WELDING MACHINE

(71) Applicant: Matt Pixley, Lodi, CA (US)

(72) Inventor: Matt Pixley, Lodi, CA (US)

(21) Appl. No.: 17/292,377

(22) PCT Filed: Nov. 6, 2019
(86) PCT No.: PCT/US19/60123

§ 371 Date: May 7, 2021

Related U.S. Application Data
(60) Provisional application No. 62/757,657, filed on Nov. 8, 2018.

(51) Int. Cl. B23K 9/10; B23K 9/095

(52) U.S. Cl. CPC B23K 9/1087; B23K 9/0953

(57) ABSTRACT

A system (10) and method (200) includes a welding machine (12) having a voltage setting, On/Off power setting, power outlet setting, welding process setting, and welding lead setting and a communication device (15), a computing device (14) including a processor programmed to enter data for an adjustment setting of at least one of the voltage setting, On/Off power setting, power outlet setting, welding process setting, and welding lead setting and communicate the adjustment setting to the welding machine (12), and a computer server (16, 100) to receive the adjustment setting from the computing device (14) and to send the adjustment setting to the communication device (15), the processor of the communication device (15) adjusting the at least one of the voltage setting, On/Off power setting, power outlet setting, welding process setting, and welding lead setting.

### CROSS-REFERENCE TO RELATED APPLICATION(S)

The present application claims the benefit of pending Provisional Patent Application, Ser. No. 62/757,657, filed Nov. 8, 2018, the entire disclosure of which is hereby expressly incorporated by reference.

### BACKGROUND OF THE INVENTION

### 1. Field of the Invention

The present invention relates generally to the field of welding machines and, more particularly, to a system and method for controlling a welding machine.

### 2. Description of the Related Art

Throughout the day of a welder or operator using a welding machine, settings are constantly needing adjustment. For example, getting further away from the welding machine requires adding lead, which in turn, requires higher voltage. Sometimes the welder of the welding machine can be serval floors up on beams. This can add time to the welder constantly going up and down to make changes in the settings. For example, even thickness changes in steel can require re-adjustment of the voltage settings. Switching welding processes also requires the welder to leave their station to go back to the welding machine. As a result, time is loss in the welder having to constantly go to the welding machine to change the settings of the welding machine throughout a day. Therefore, there is a need in the art to remotely adjust at least one setting of a welding machine when the operator is away from the welding machine.

In addition, welding machines are constantly in need of attention such as fuel level, water level, oil, etc. Welding machines are typically located at jobsites and these jobsites get very busy and forgetting to check the welding machine for such things such as fuel level, water level, oil, etc. can be costly. Therefore, there is a need in the art to notify or communicate with a welder, operator, or foreman when the welding machine needs attention.

### SUMMARY OF THE INVENTION

The present invention provides a system for controlling a welding machine having a voltage setting, On/Off power setting, power outlet setting, welding process setting, and welding lead setting and a communication device including a processor in communication with the welding machine. The system also includes a computing device including a processor programmed to enter data for an adjustment setting of at least one of the voltage setting, On/Off power setting, power outlet setting, welding process setting, and welding lead setting of the welding machine and communicate the adjustment setting to the welding machine. The system further includes a computer server including a processor programmed to receive the adjustment setting from the computing device and to send the adjustment setting to the communication device of the welding machine, the processor of the communication device of welding machine adjusting the at least one of the voltage setting, On/Off power setting, power outlet setting, welding process setting, and welding lead setting based on the adjustment setting.

The present invention also provides a method for controlling a welding machine including the steps of providing a welding machine having a voltage setting, On/Off power setting, power outlet setting, welding process setting, and welding lead setting and a communication device including a processor in communication with the welding machine. The method also includes the steps of receiving a message from a computing device including a processor, determining whether at least one of the voltage setting, On/Off power setting, power outlet setting, welding process setting, and welding lead setting needs adjustment, and entering data for an adjustment setting of the least one of the voltage setting, On/Off power setting, power outlet setting, welding process setting, and welding lead setting of the welding machine in the computing device. The method further includes the steps of communicating the adjustment setting to a computer server including a processor programmed to receive the adjustment setting from the computing device, communicating the adjustment setting to the communication device of the welding machine, and adjusting the at least one of the voltage setting, On/Off power setting, power outlet setting, welding process setting, and welding lead setting based on the adjustment setting.

Other advantages of the present disclosure will be readily appreciated, as the same becomes better understood by reference to the following detailed description when considered in connection with the accompanying drawings.

### BRIEF DESCRIPTION OF THE DRAWINGS

FIG. 1 is a schematic illustrating various aspects of a system, according to the present invention, illustrated with a welding machine.

FIG. 2 illustrates a component of a user computing device that may be used with the system shown in FIG. 1.

FIG. 3 is a perspective view of one embodiment of a welding machine that may be used with the system shown in FIG. 1.

FIG. 4 is a schematic illustrating example components of a server computer that may be used with the system shown in FIG. 1.

FIG. 5 is a flowchart of a method, according to the present invention, of controlling a welding machine that may be used with the system shown in FIG. 1.

Corresponding reference characters indicate corresponding components throughout the several views of the drawings.

### DESCRIPTION OF THE PREFERRED EMBODIMENT(S)

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, a reasonable programmable read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

In general, the present invention includes a system 10 such as a networked computer system that is configured to control a welding machine 12. The system 10 includes application software that enables the system 10 to provide a platform for controlling the welding machine 12 such as turning the welding machine Off and On, adjusting voltage settings on the welding machine, etc. It should be appreciated that the system 10 allows the welder or operator of the welding machine 12 to remotely communicate and control the welding machine 12 and receive notifications from the welding machine 12.

The application software provides the system 10 with a platform to allow the welder or operator of the welding machine 12 to control settings of the welding machine 12 with a user computing device 14 such as a smart phone, smart watch, tablet, etc. The system 10 also has a communication device 15 that can receive communications from the operator and send notifications from the welding machine 12 to the operator and/or another person such as a foreman at a jobsite. The communication device 15 includes a processor in communication with the welding machine 12. In one embodiment, the communication device 15 is a transceiver operatively connected to the welding machine 12. The application software allows the operator to spend less time going back and forth to the welding machine 12 to physically adjust the settings, for example voltage settings, amp settings, On/Off power settings, power outlet settings, welding process settings, and welding lead settings, of the welding machine 12. The application software includes a program version that includes a user version available in all the application stores and potentially pre-installed as a part of default carrier software loads (for example: AT&T, Sprint, Verizon, etc.) that will provide the functionality to be described below. The system 10 may also include a mobile computer application being stored on the user computing device 14, for example a mobile computing device, associated with the user. The mobile application uses location and public API's to send notifications to the user. For example, in one embodiment, the operator may receive a notification from the welding machine 12 about a condition such as low fuel level, low oil level, low water level, etc. It should be appreciated that the processor of the communication device 15 may cooperate with one or more processors of the welding machine 12 to adjust the settings of the welding machine 12. It should also be appreciated that “user” and “operator” may be used interchangeably throughout the description.

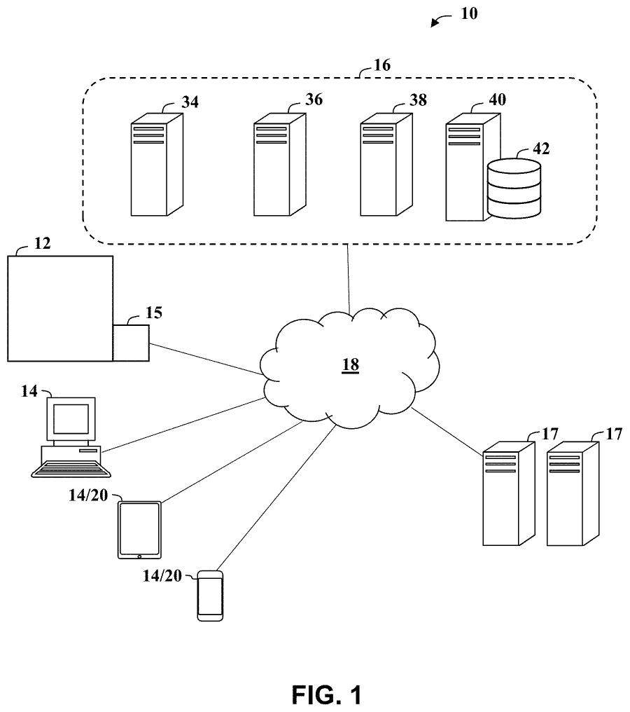

Referring to FIG. 1, in the illustrated embodiment, the system 10 includes a server system 16 that is coupled in communication with one or more user computing devices 14 and one or more 3^{rd} party computer servers 17 via a communications network 18. The server system 16 may be any suitable server, including an internet transaction server (ITS), an ATG application server or an ATG application instance, a Dynamo server, etc . . . , and may utilize any suitable or combination of technologies configured to enable efficient communication. The communications network 18 may be any suitable connection, including the Internet, Voice Over IP (VoIP), file transfer protocol (FTP), an Intranet, LAN, a virtual private network (VPN), cellular networks, etc . . . , and may utilize any suitable or combination of technologies including, but not limited to wired and wireless connections, always on connections, connections made periodically, and connections made as needed.

The user computing device 14 may include any suitable device that enables the user to access and communicate with the system 10 including sending and/or receiving information to and from the system 10 and displaying information received from the system 10 to the user. For example, in one embodiment, the user computing device 14 may include, but is not limited to, a desktop computer, a laptop or notebook computer, a tablet computer, a smartphone/tablet computer hybrid, a personal data assistant, a handheld mobile device including a cellular telephone, a smart watch, and the like. The user computing device 14, as well as any other connected computer systems and their components included in the system 10, can create message related data and exchange message related data (e.g., near field communication (“NEC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

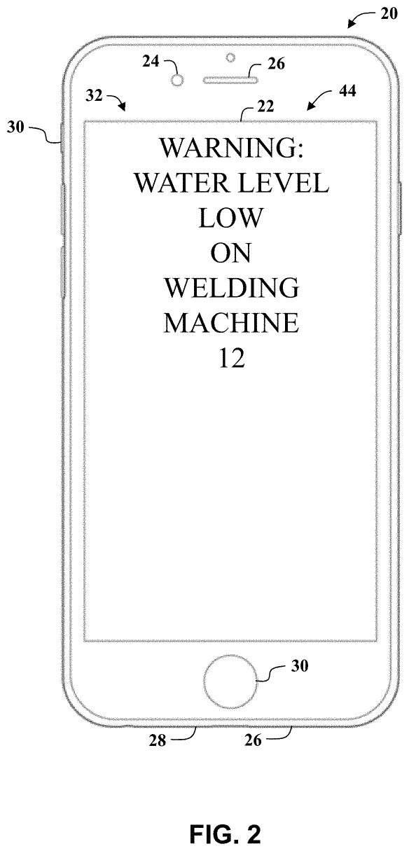

In one embodiment, the user computing device 14 includes a mobile computing device 20 (shown in FIG. 2) such as, for example, a smartphone such as an iPhone™. The mobile computing device 20 includes a processor coupled to a memory device, and a database for storing various programs and data for use in operating the mobile computing device 20. The mobile computing device 20 may also include a touchscreen display device 22, one or more video image cameras 24, one or more speakers 26, a microphone 28, at least one input button 30, and one or more sensors including, but not limited to, a touch ID fingerprint sensor coupled to an input button 30, a barometer, a three-axis gyro, an accelerometer, proximity sensor, and an ambient light sensor. In addition, the mobile computing device 20 may also include a Wi-Fi antenna, a cellular network antenna, a Bluethooth™ communications device, assisted GPS and GLONASS, a digital compass, and an iBeacon microlocation device.

In the illustrated embodiment of FIG. 2, the mobile computing device 20 includes a web browser programmed and stored in the memory device. The processor executes the web browser program to display web pages on the touchscreen display device 32 that includes information received from the server system 16 to enable the user to interact with and operate the server system 16. In addition, the mobile computing device 20 may be programmed to store and execute a mobile program application, e.g., a mobile application, that displays a user interface 32 on the touch screen display device 22 that allows the user to access the server system 16 to retrieve and store information within the server system 16 as well as interact with and operate the server system 16. In addition, in one embodiment, the system 10 may install one or more mobile application programs in the memory device of the mobile computing device 20. When initiated by the processor of the mobile computing device 20, the mobile application program causes the processor of the mobile computing device 20 to perform some or all of the functions of the server system 16. It should be appreciated that the mobile application program provides partial or full control of the welding machine 12. It should also be appreciated that the mobile computing device 20 allows for voice control or hand-free control of the user interface 32 such that the mobile application program can execute partial or full control of the welding machine 12, for example adjusting the setting of the voltage, based on voice commands from the operator or welder.

In one embodiment, the mobile application program is compatible with social media such as Facebook® so each welding machine 12 could have a name, profile, and page. For example, E. L. Erectors Machine #3, having a page to show who is linked to this welding machine 12, hours of use, if a “low oil” notification was ignored, etc. It should be appreciated that inspectors could access the page for parameter inspection. It should also be appreciated that the mobile computing device 20 may be aligned or linked with the welding machine 12 via a “smart label”.

In another embodiment, the mobile application program may have advertisements to allow companies that want to advertise to the user of the mobile application program. In addition, the mobile application program may be associated with a data plan that will eliminate the need for a low jack and the amount of money being saved with surpass the monthly costs.

The 3^{rd} party computer servers 17 may include information and data associated with the welding machine 12. For example, in one embodiment, the 3^{rd} party computer servers 17 may include information associated with the welding machine 12 that receives a request to send information about the welding machine 12 to the user.

In the illustrated embodiment of FIG. 1, the server system 16 includes one or more servers such as a website hosting server 34, an application server 36, an external server 38, a database server 40, and a database 42. The database server 40 includes a memory device that is connected to the database 42 to retrieve and store information contained in the database 42. The database 42 contains information on a variety of matters, such as, for example, web pages associated with one or more websites, a plurality of user records, a plurality of user IDs, a plurality of mobile IDs, including welding machines 12, notification messages, mobile computing device identifiers, mobile device application program interfaces (APIs), and/or any suitable information that enables the system 10 to function as described herein. In one embodiment, some or all of the information contained in the database 42 may also be stored in the database of the mobile computing device 20.

In the one embodiment, the database 42 includes a user records list that includes a plurality of user records. Each user record includes a unique user profile. Each user profile includes a unique user ID associated with a user and a mobile ID associated with a mobile computing device 20. The unique user ID includes user identifying data such as, for example, a unique ID and/or password; and may also include user contact information such as, for example, a phone number, an e-mail, and/or a mobile device data associated with a mobile computing device 20 associated with the user. For example, the mobile device data may include, but is not limited to, the unique mobile device ID, operating system, phone number, IP address, mobile device API, and/or any suitable information that enables the system 10 to communicate with the corresponding mobile computing device 20.

The database 42 may also include messaging information 44 including data and information to be sent with a mobile computing device 20 associated with the corresponding user profile and/or API information associated with the corresponding mobile computing device 20. In one embodiment, the messaging information 42 may also include contact information such as, for example, emails, and/or text and phone numbers. The application server 38 may identify one or more additional users that may receive notifications generated by the website hosting server 34 and include contact information associated with the identified additional users in the messaging information 80 that has sent or received a message using the system 10.

The website hosting server 34 is configured to host a website that is accessible by the user via one or more of the user computing devices 14. The website hosting server 34 retrieves and stores web pages associated with one or more websites in response to requests received by the user via the user computing device 14 to allow users to interact with the website and send and receive messages to and from one or more of the welding machines 12 at a jobsite. In one embodiment, the website hosting server 34 is configured to generate and display the messages on the user computing device 14 in response to messages being sent and received from the welding machines 12 via the corresponding web browsers that are displayed on the user computing devices 14. In addition, the website hosting server 34 may be configured to generate and display a mobile web page, the mobile web page can be displayed on one or more mobile computing devices 20.

In the illustrated embodiment, the application server 36 is programmed to monitor activities associated with the plurality of user records and process the messages being sent and received. Once the application server 36 receives a message from the user profile, the application server 36 may be configured to determine whether the user profile is a current user profile or not. If the user profile is not a current user profile, the application server may send a message to the user in order for the user to opt-into the system 10. The application server 36 is further configured to pair the user profile with the welding machine 12 by accessing the database 42 to receive the data including the welding machine 12 that is paired with the user profile. In another embodiment, the user profile may be paired with more than one welding machine 12.

The application server 36 is configured to receive information from the website hosting server 34, and send the information to the database server 40 to be stored in the database 42. In another embodiment, the database server 40 receives all of the information collected by the application server 36 and stores the information in the database 42. It should be appreciated that this information includes messages sent and received and user profiles.

The external server 38 is configured to interact with the 3rd party server 17 that is outside of the application server 36. In addition, the external server 38 is configured to connect with the 3rd party server 17 using secret authentication mechanisms, application keys, call different methods on the external server 38, APIs, and reformat the results of the data back for use by the application server 36 so that the application server 36 can send the data to the website hosting server 34 to be displayed on the user computing device 14. The external server 38 is configured to be a bridge between the products and/or services completely separate from the application server 36. It should be appreciated that the products and/or services that are outside of the application server 38 include all external services.

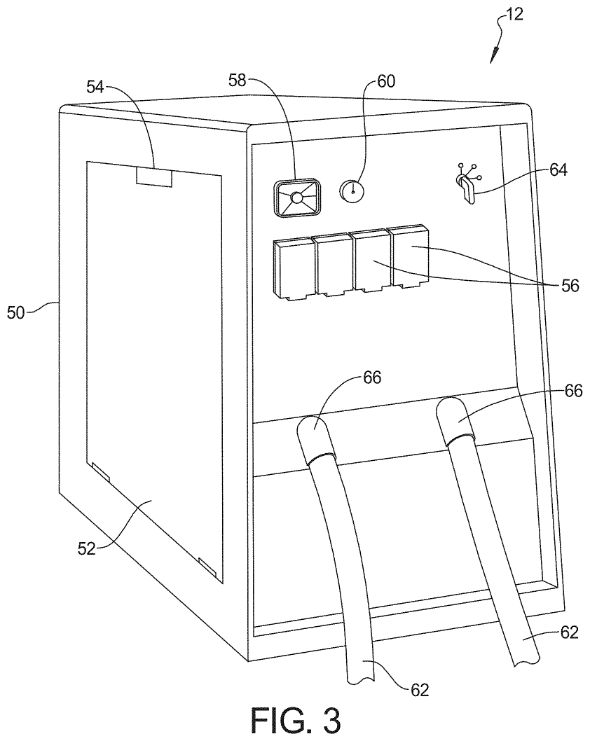

Referring to FIG. 3, one embodiment of the welding machine 12 is shown for use with the system 10. The welding machine 12 includes a housing 50 having a maintenance door 52. The maintenance door 52 allows an operator to check the level of oil, spark plugs, etc. The welding machine 12 also includes a safety switch 54 to ensure that the welding machine 12 cannot start while the maintenance door 52 is open to avoid possible injury. It should be appreciated that the safety switch 54 may send a signal to the processor of the communication device 15 of the welding machine 12 that the maintenance door 52 is open and the processor sends a communication to the server system 16 that the maintenance door 52 is open.

The welding machine 12 includes one or more power outlets 56 coupled to the housing 50. The power outlets 56 are “smart outlets” that can be accessed by the operator through a mobile application program to be described. A setting of the power outlets 56 may be adjusted such that either individual or a plurality of the power outlets 56 may be active to supply power. It should be appreciated that grinders and heavy power tools are constantly tripping GFI breakers, causing loss of time.

The welding machine 12 also includes a welding process selector switch 58 coupled to the housing 50. The welding process selector switch 58 is a digital push button style switch that can be accessed through the mobile application program. The welding process selector switch 58 has one or more settings that may be adjusted to select the type of welding to be performed. It should be appreciated that different types of welding require that the welding process selector switch 58 be adjusted periodically throughout the day, causing loss of time.

The welding machine 12 further includes a voltage dial 60 coupled to the housing 50 to adjust the amount of voltage supplied to welding lead cables 62. The voltage dial 60 can be accessed through the mobile application program. The voltage dial 60 has a setting that may be adjusted to increase or decrease the amount of voltage supplied. It should be appreciated that the voltage dial 60 requires periodic adjustment based on the welding material.

The welding machine 12 includes an On/Off power switch 64 coupled to the housing 50. The On/Off power switch 60 allows for starting On and shutting Off the welding machine 12 or to idle the welding machine 12. The On/Off power switch 64 can be accessed through the mobile application program. The On/Off power switch 64 may be adjusted to allow for automatic shutdown to make the welding machine 12 more fuel efficient and less pollutant. The On/Off power switch 64 has three different settings such as On, Off, and Idle. It should be appreciated that going to and from lunch breaks that turning the welding machine 12 On/Off manually can easily be forgotten. It should also be appreciated that even waiting on different variables can cause countless hours of idle time, which is causing unnecessary pollution.

The welding machine 12 also includes welding lead connections 66 coupled to the housing 50. The welding lead connections 66 can be accessed through the mobile application program to switch internal polarity of the welding lead cables 62. The welding lead connections 66 have a setting that may be adjusted for the internal polarity of the welding lead cables 62. It should be appreciated that the welding lead connections 66 require switching periodically throughout the day, for example, stick welding requires a negative ground while a wire feeder requires a positive ground, which requires countless trips by the operator to manually switch the polarity.

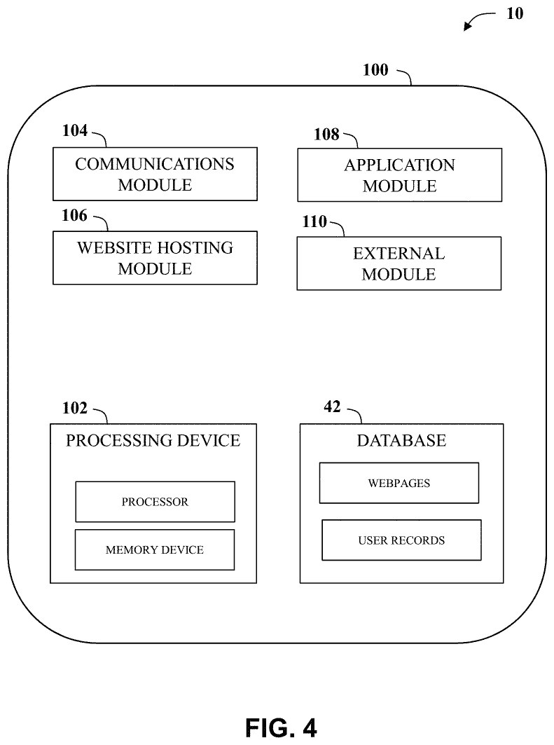

Referring to FIG. 4, in one embodiment, the system 10 may include a system server 100 that is configured to perform the functions of the website hosting server 34, the application server 36, the external server 38, and the database server 40. In the illustrated embodiment, the system server 100 includes a processing device 102 and the database 42.

The processing device 102 executes various programs, and thereby controls components of the system server 100 according to user instructions received from the user computing device 14. The processing device 102 may include memory, e.g., read only memory (ROM) and random access memory (RAM), storing processor-executable instructions and one or more processors that execute the processor-executable instructions. In embodiments where the processing device 102 includes two or more processors, the processors can operate in a parallel or distributed manner. In an example, the processing device 102 may execute a communications module 104, a website hosting module 106, an application module 108, and an external module 110.

The processing device 102 may also include a memory device for storing programs and information in the database 42, and retrieving information from the database 42 that is used by the processor to perform various functions described herein. The memory device may include, but is not limited to, a hard disc drive, an optical disc drive, and/or a flash memory drive. Further, the memory device may be distributed and located at multiple locations.

The communications module 104 retrieves various data and information from the database 42 and sends information to the user computing device 14 via the communications network 18 to enable the user to access and interact with the system 10. In one embodiment, the communications module 104 displays various images on a graphical interface of the user computing device 14 preferably by using computer graphics and image data stored in the database 42 including, but not limited to, user records, messages, and/or any suitable information and/or images that enable the system 10 to function as described herein.

The website hosting module 106 may be programmed to perform some or all of the functions of the website hosting server 34 including hosting various web pages associated with one or more websites that are stored in the database 42 and that are accessible to the user via the user computing device 14. The website hosting module 106 may be programmed to generate and display webpages associated with a website in response to requests being received from users via corresponding web browsers.

The application module 108 may be programmed to perform some or all of the functions of the application server 36 including sending and receiving messages amongst the users, processing the messages, detecting events or actions, and/or generating the messages between all of the modules.

The external module 110 may be programmed to perform some or all of the functions of the external server 38 including generating, receiving, and storing the external data including data from the 3rd party server computer 17.

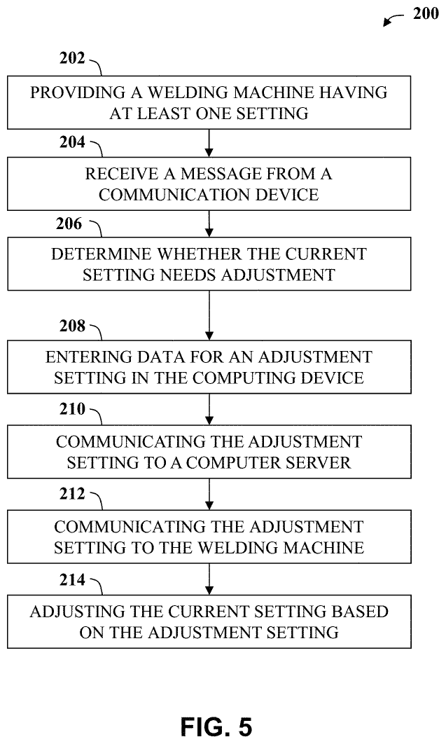

Referring to FIG. 5, a flowchart of one embodiment of a method 200, according to the present invention, that may be used with the system 10 for controlling the welding machine 12. The method 200 includes a plurality of steps. Each method step may be performed independently of, or in combination with, other method steps. Portions of the method may be performed by any one of, or any combination of, the components of the system 10.

In method step 202, a welding machine 12 is provided, for example at a jobsite, having a plurality of settings for operating the welding machine 12. In one embodiment, the welding machine 12 has a voltage setting, On/Off power setting, power outlet setting, welding process setting, and welding lead setting. The welding machine 12 also has the communication device 15 including a processor in communication with the welding machine 12. The processor is configured to adjust at least one of the voltage setting, On/Off power setting, power outlet setting, welding process setting, and welding lead setting of the welding machine 12 in response to receiving input from a user computing device 14.

In method step 204, a computer server of the server system 16 is configured to receive a message from the communication device 15 of the welding machine 12. In one embodiment, the processor of the communication device 15 of the welding machine 12 has the at least one of the voltage setting, On/Off power setting, power outlet setting, welding process setting, and welding lead setting of the welding machine 12 that is sent wirelessly over the network 18 to the computer server of the server system 16.

In method step 206, the operator of the welding machine 12 determines whether the current setting of at least one of the voltage setting, On/Off power setting, power outlet setting, welding process setting, and welding lead setting of the welding machine 12 needs adjustment. In one embodiment, the user computer device 14 includes a processor programmed to determine whether the current setting of at least one of the voltage setting, On/Off power setting, power outlet setting, welding process setting, and welding lead setting of the welding machine 12 needs adjustment and/or the amount of adjustment.

Further, in method step 208, the user enters data for an adjustment setting of the at least one of the voltage setting, On/Off power setting, power outlet setting, welding process setting, and welding lead setting of the welding machine 12 in the user computing device 14. In one embodiment, the operator enters the data through the mobile application program on the user computing device 14, for example, a voltage setting into the user computing device 14 that increases or decreases the amount of voltage to the welding lead cables 62 of the welding machine 12. It should be appreciated that the operator may enter through the mobile application program on the user computing device 14 for one or more settings such as the voltage setting, amp setting, On/Off power setting, power outlet setting, welding process setting, and welding lead setting of the welding machine 12.

In method step 210, the computer server of the server system 16 communicates the adjustment setting to the welding machine 12. In one embodiment, a computer server of the server system 16 includes a processor programmed to send the adjustment setting wirelessly over the network 18 to the welding machine 12.

In method step 214, the communication device 15 of the welding machine 12 receives the adjustment setting and the processor of the communication device 15 adjusts the current setting of at least one of the voltage setting, On/Off power setting, power outlet setting, welding process setting, and welding lead setting of the welding machine 12. In one embodiment, the processor of the communication device 15 of the welding machine 12 adjusts, for example, the voltage setting up or down to increase or decrease, respectively, the amount of voltage to the welding lead cables 62. The processor of the communication device 15 of the welding machine 12 may adjust one or more of the voltage setting, amp setting, On/Off power setting, power outlet setting, welding process setting, and welding lead setting of the welding machine 12. It should be appreciated that the method 200 could be used for other settings of the welding machine 12.

In another embodiment, the processor of the communication device 15 of the welding machine 12 communicates a message that the welding machine 12 is in need of attention such as low fuel level, water level, oil, etc. The processor of the communication device 15 of the welding machine 12 sends the message wirelessly over the network 18 to the computer server of the server system 16. The computer server of the server system 16, in turn, includes a processor programmed to send the message wirelessly over the network 18 to one or more of the user computing devices 14.

In yet another embodiment, during stick welding, the operator or welder may adjust the setting of the amps based on thickness of the material and/or the length of the welding lead cables 62. Because the processor of the communication device 15 is at the welding machine 12, the processor can adjust the amp setting of the welding machine 12 which cannot be accomplished on a wire feeder. It should be appreciated that the processor of the communication device 15 may cooperate with one or more processors of the welding machine 12 to adjust the settings of the welding machine 12 for stick welding.

A controller, computing device, server or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

The present invention has been described in an illustrative manner. The above description of illustrated examples of the present invention, including what is described in the Abstract, are not intended to be exhaustive or to be limitation to the precise forms disclosed. While specific embodiments of, and examples for, the present invention are described herein for illustrative purposes, various equivalent modifications are possible without departing from the broader spirit and scope of the present invention.

1. A system (10) for controlling a welding machine (12) comprising:
a welding machine (12) having a voltage setting, On/Off power setting, power outlet setting, welding process setting, and welding lead setting and a communication device (15) including a first processor in communication with the welding machine (12);
a remote user computing device (14) including a second processor and a user interface (32) programmed to allow a remote user of the welding machine (12) located remotely from the welding machine (12) to enter data for an adjustment setting of at least one of the voltage setting, On/Off power setting, power outlet setting, welding process setting, and welding lead setting of the welding machine (12) in the user interface (32) and communicate the adjustment setting to the welding machine (12) setting to allow the remote user to control the welding machine (12); and
a computer server (16, 100) including a third processor programmed to receive the adjustment setting from the remote user computing device (14) and to send the adjustment setting to the communication device (15) of the welding machine (12), the first processor of the communication device (15) of welding machine (12) adjusting the at least one of the voltage setting, On/Off power setting, power outlet setting, welding process setting, and welding lead setting based on the adjustment.

2. A system (10) as set forth in claim 1, wherein the remote user computing device (14) is further configured to receive a message from the computer server (16, 100).

3. A system (10) as set forth in claim 1, wherein the first processor of the communication device (15) of the welding machine (12) is further configured to determine a fuel level of the welding machine (12) and to communicate a message to the computer server (16, 100) if the fuel level is below a predetermined level.

4. A system (10) as set forth in claim 1, wherein the first processor of the communication device (15) of the welding machine (12) is further configured to determine a water level of the welding machine (12) and to communicate a message to the computer server (16, 100) if the water level is below a predetermined level.

5. A system (10) as set forth in claim 1, wherein the first processor of the communication device (15) of the welding machine (12) is further configured to determine an oil level of the welding machine (12) and to communicate a message to the computer server (16, 100) if the oil level is below a predetermined level.

6. A system (10) as set forth in claim 1, wherein the computer server (16, 100) is further configured to communicate a message to the computing device (14).

7. A system (10) as set forth in claim 1, including a wireless network (18) to communicate between the remote user computing device (14), the computer server (16, 100), and the communication device (15) of the welding machine (12).

8. A system (10) as set forth in claim 1, wherein the remote user computing device (14) is one of a desktop computer, a laptop or notebook computer, a tablet computer, a smartphone/tablet computer hybrid, a personal data assistant, a handheld mobile device comprising one of a cellular telephone and a smart watch.

9. A system (10) as set forth in claim 1, wherein the remote user computing device (14) includes a touch screen display device (22), wherein the second processor is programmed to store and execute a mobile program application that displays the user interface (32) on the touch screen display device (22) and allows the user to access the server system (16) to retrieve and store information within the server system (16).

10. A method (200) for controlling a welding machine (12) comprising the steps of:
providing a welding machine (12) having a voltage setting, On/Off power setting, power outlet setting, welding process setting, and welding lead setting and a communication device (15) including a first processor in communication with the welding machine (12);
receiving a message from a remote user computing device (14) including a second processor and a user interface (32);
determining whether at least one of the voltage setting, On/Off power setting, power outlet setting, welding process setting, and welding lead setting needs adjustment;
entering, by a remote user of the welding machine (12) located remotely from the welding machine (12), data for an adjustment setting of the least one of the voltage setting, On/Off power setting, power outlet setting, welding process setting, and welding lead setting of the welding machine (12) in the user interface (32) of the remote user computing device (14) setting to allow the remote user to control the welding machine (12);
communicating the adjustment setting to a computer server (16, 100) including a third processor programmed to receive the adjustment setting from the remote user computing device (14);
communicating the adjustment setting to the communication device (15) of the welding machine (12); and
adjusting the at least one of the voltage setting, On/Off power setting, power outlet setting, welding process setting, and welding lead setting by the communication device (15) based on the adjustment setting.

11. A method (200) as set forth in claim 10, wherein the remote user computing device (14) is further configured to receive a message from the computer server (16, 100).

12. A method (200) as set forth in claim 10, including the step of determining a fuel level of the welding machine (12) by the first processor of the communication device (15) and communicating a message to the computer server (16, 100) if the fuel level is below a predetermined level.

13. A method (200) as set forth in claim 10, including the step of determining a water level of the welding machine (12) by the first processor of the communication device (15) and communicating a message to the computer server (16, 100) if the water level is below a predetermined level.

14. A method (200) as set forth in claim 10, including the step of determining an oil level of the welding machine (12) by the first processor of the communication device (15) and communicating a message to the computer server (16, 100) if the oil level is below a predetermined level.

15. A method (200) as set forth in claim 10, including the step of communicating, by the computer server (16, 100), the message to the remote user computing device (14).

16. A method (200) as set forth in claim 10, including the step of communicating over a wireless network (18) between the remote user computing device (14), computer server (16, 100), and the communication device (15) of the welding machine (12).

17. A method (200) as set forth in claim 10, wherein the remote user computing device (14) is one of a desktop computer, a laptop or notebook computer, a tablet computer, a smartphone/tablet computer hybrid, a personal data assistant, a handheld mobile device comprising one of a cellular telephone and a smart watch.

18. A method (200) as set forth in claim 10, wherein the remote user computing device (14) is programmed to store and execute a mobile program application that displays the user interface (32) on a touch screen display device (22) of the computing device (14) that allows the user to access the server system (16) to retrieve and store information within the server system (16, 100).
